(19) United States
(12) Patent Application Publication
(10) Pub. No.: US 2025/0285105 A1
(43) Pub. Date: Sep. 11, 2025

(54) SYSTEM AND METHOD FOR CREDIT CARD MANAGEMENT

(71) Applicant: MOTOROLA MOBILITY LLC, WILMINGTON, DE (US)

(72) Inventors: AMIT KUMAR AGRAWAL, BANGALORE (IN); SOMINA LAKSHMANA HANUMAN MAHATH, BENGALURU (IN); VIJAYPRAKASH IDLUR, IDLUR (IN)

(21) Appl. No.: 18/601,945

(22) Filed: Mar. 11, 2024

(51) Int. Cl. G06Q 20/36; G06Q 20/22; G06Q 20/34

(52) U.S. Cl. CPC G06Q 20/36; G06Q 20/227; G06Q 20/351

(57) ABSTRACT

A method provides techniques for credit card management. The method includes identifying an intended spend amount for a financial transaction to be paid for via use of one of multiple payment sources within the digital wallet. The method further includes determining, in part based on the intended spend amount, the minimum spending criteria, and the end/renewal data, a preferred payment source from among the multiple payment sources to suggest for use in completing the financial transaction, while maximizing a collective financial benefit of selectively utilizing the multiple payment sources within the digital wallet to complete financial transactions up to and following the end/renewal date. The method continues with presenting, on an output device, an indication to utilize a particular payment source in response to determining that reducing a balance remaining to meet the minimum spending criteria is a best option to maximize the collective financial benefit.

### BACKGROUND

### 1. Technical Field

The present disclosure generally relates to portable electronic devices, and more specifically to portable electronic devices that enable use of a digital wallet.

### 2. Description of the Related Art

Using a digital wallet for personal financial transactions offers several benefits, including convenience, security, and efficiency in financial transactions. Digital wallets simplify completing payment transactions by allowing users to store multiple payment methods in one place, streamlining the payment process. Payments can be made swiftly with just a few clicks or taps, reducing the time and effort required, compared to traditional payment methods. Furthermore, digital wallets typically utilize advanced encryption and authentication measures, enhancing the security of the financial transactions. Moreover, digital wallets enable contactless payments using technologies like NFC, reducing the need for physical credit/debit cards. By using a digital wallet that is accessed from an electronic device such as a smartphone, users can minimize the need to carry multiple physical cards and receipts, reducing the risk of loss or theft. Yet another advantage of digital wallets is that in the event of a lost or stolen physical wallet, digital wallets often have backup and recovery options, ensuring access to funds without the need for physical cards.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to manage payment sources within a digital wallet, according to one or more embodiments;

FIG. 2 depicts multiple exemplary payment sources that are managed within a digital wallet, according to one or more embodiments;

FIG. 3 is an example illustration of an electronic device transmitting a request for payment source data to an application computer system and receiving a response from the application computer system for setting up payment source information in a digital wallet, according to one or more embodiments;

FIG. 4 illustrates an exemplary user interface for payment source recommendation within a digital wallet, according to one or more embodiments;

FIG. 5A illustrates an exemplary user interface for payment source recommendation within a digital wallet using a pay in full option, according to one or more embodiments;

FIG. 5B illustrates an exemplary user interface for payment source recommendation within a digital wallet using a pay over time option, according to one or more embodiments;

FIG. 6 illustrates an exemplary user interface for payment source confirmation within a digital wallet, according to one or more embodiments;

FIG. 7 illustrates an exemplary user interface depicting payment source summary information within a digital wallet, according to one or more embodiments;

FIG. 8 depicts a flowchart of a method for presenting an indication to utilize a preferred payment source in order to maximize the collective financial benefit, according to one or more embodiments; and

FIG. 9 depicts a flowchart for computing a score used for ranking a payment source, according to one or more embodiments.

### DETAILED DESCRIPTION

According to aspects of the present disclosure, an electronic device, a method, and a computer program product provide techniques for automatically managing selection of a best payment mechanism from among a plurality of available payment mechanisms, that results in minimizing periodic fees, such as annual fees based on minimum spend amounts, balanced against other payment-related considerations. The method includes identifying, by a processor of an electronic device, an intended spend amount for a financial transaction to be paid for via use of one of a plurality of payment sources within a digital wallet. The plurality of payment sources includes at least a first payment source that has a periodic account fee that is automatically applied at an end/renewal date of a tracked period, based on a total spend amount using the first payment source during the tracked period not reaching a minimum spending criteria. The method includes determining a preferred payment source from among the plurality of payment sources to suggest for use in completing the financial transaction. The determination can be based at least in part, on the intended spend amount, the minimum spending criteria, and/or the end/renewal date. An indication is presented on an output device, where the indication prompts utilization of the particular payment source in response to determining that reducing a balance remaining to meet the minimum spending criteria for that payment source is a best option to maximize the collective financial benefit of using the plurality of payment mechanisms. A financial benefit can include a benefit of value, such as money, points, or other non-monetary benefits. As an example, spending above a predetermined limit on a credit card can unlock a benefit such as priority boarding of on an airline, lounge privileges at an airport, etc.

Managing multiple payment sources such as credit cards with varying annual fees, spending requirements, interest rates, and reward mechanisms can pose several challenges. With each credit card having its own set of terms, conditions, and features, managing multiple cards can become confusing. Remembering due dates, rewards structures, and other details becomes challenging, leading to potential mistakes and/or missed opportunities for taking advantage of rewards and/or fee waivers. Different credit cards may have different periodic fees, such as annual fees and/or monthly fees. In some cases, the periodic fees may be waived when the spending on a given credit card exceeds a predetermined threshold by a certain date. Keeping track of the fee waiver thresholds, current remaining amounts to spend or current spend amounts in the period, and deadlines to reach the thresholds can be time-consuming and may require detailed record-keeping. Some credit cards come with spending requirements to unlock certain benefits, such as sign-up bonuses or rewards. Juggling these multiple spending thresholds can be challenging, and failing to meet one or more of these spend thresholds may result in missed opportunities. If not carefully managed, the use of multiple payment sources, such as credit cards with periodic fees and complex reward structures, can end up costing a user more than the benefits those credit cards can provide.

The disclosed embodiments alleviate the aforementioned issues caused by the complexity of managing multiple payment sources. According to the disclosure, payment source metadata is retrieved from one or more sources, such as financial institutions. The payment source can include a credit card, debit card, rewards account, cryptocurrency account, and/or other type of payment account. The payment source metadata can include current balance, available credit limit, interest rate, a fee waiver threshold, a fee waiver threshold deadline, and/or other parameters associated with a payment source. In one or more embodiments, payment source metadata may be entered manually by a user, instead of, or in addition to retrieving payment source metadata from financial institutions (e.g., via information retrieval from servers). In one or more embodiments, a user may ‘opt-in’ to allow payment source metadata to be electronically collected by an application, such as a digital wallet application. In one or more embodiments, the digital wallet application executes on an electronic device such as a smartphone associated with the user. In one or more alternate embodiments, the digital wallet application may execute on a remote server, cloud server, virtualized environment, and/or other network-accessible server. In these alternate embodiments, an application (app) executing on the electronic device (e.g., smartphone of the user) processes network requests and responses to interface with the digital wallet application, and the app provides a user interface that is rendered on the electronic device.

According to one or more embodiments, the digital wallet application, receives or pulls payment source metadata from the electronic records within the user's account at the institution's online portal. The payment source metadata can include a periodic fee. The periodic fee can include an annual fee, monthly fee, and/or other type of fee. The payment source metadata can include an existence of a fee waiver threshold. The fee waiver threshold, if present for a given payment source, indicates an amount (e.g., in USD, or other suitable currency) of purchases/activity that, if exceeded within a predetermined duration, results in waiving of the periodic fee. The payment source metadata can include a current activity level for a payment source. The current activity level can include an amount of spending/usage for a payment source over a given interval of time, which is denoted by an end/renewal date of a tracked/monitored period. The payment source metadata can include rewards structure information. The rewards structure information can include purchase/activity thresholds that unlock rewards, interest rates on pending balances, as well as the value of the rewards (points, cash back, etc.), that are unlocked.

According to one or more embodiments, an artificial intelligence (AI) module operating within the device that is executing the digital wallet application performs one or more spend analyses (such as what-if scenarios) at the time of an initiated purchase to determine a payment source that maximizes a collective financial benefit. To illustrate an example, a user has two credit cards, credit card A, and credit card B. Credit card A has an annual fee of $100 that is waived if annual usage exceeds $5,000, and credit card B has an annual fee of $500 that is waived if annual usage exceeds $10,000. The current annual activity on card A is $3,000, and the current annual activity on card B is $9,950. The user initiates a purchase of $70 on his/her electronic device (e.g., using the digital wallet application). Disclosed embodiments identify that the proposed purchase, if transacted using card B, will result in the user exceeding the fee waiver threshold for credit card B, thereby saving the $500 annual fee. In one or more embodiments, the digital wallet may recommend a payment source to be used for a proposed purchase. The user can then opt to use the recommended payment source or to use a different payment source. In one or more embodiments, the fee waiver threshold deadline may also be used as a criterion in determining a recommended payment source. Continuing with the aforementioned example, if the fee waiver threshold deadline for card B is a few months into the future, and the threshold deadline for card A is a few weeks into the future, then card A may be selected as the recommended payment source. Other criteria may also be used in making the determination of recommended payment source. In one or more embodiments, the digital wallet may automatically use the recommended payment source without any additional user interaction, thereby streamlining the purchasing process. These, and other advantages of disclosed embodiments are further explained in the following detailed description.

One or more embodiments can include an electronic device including: at least one output device, including a display; a communication system; and a memory having stored thereon a digital wallet module which when executed determines and present a suggested payment source to complete a financial transaction, from among a plurality of payment sources within a digital wallet, in part to minimize or eliminate incurring a periodic account fee of the suggested payment source. The electronic device includes at least one processor communicatively coupled to the display, the communication system, and the memory, the at least one processor executing program code of the digital wallet module which enables the electronic device to identify an intended spend amount for a financial transaction to be paid for via use of one of the plurality of payment sources within the digital wallet. The plurality of payment sources includes at least a first payment source that has a periodic account fee that is automatically applied at an end/renewal date of a tracked period, based on a total spend amount using the first payment source during the tracked period not reaching a minimum spending criteria. The program code of the digital wallet module further enables the electronic device to determine, in part based on the intended spend amount, the minimum spending criteria, and the end/renewal date, a preferred payment source from among the plurality of payment sources to suggest for use in completing the financial transaction, while maximizing a collective financial benefit of selectively utilizing the plurality of payment sources within the digital wallet to complete financial transactions up to and following the end/renewal date. The program code of the digital wallet module further enables the electronic device to present, on an output device, an indication to utilize the first payment source in response to determining that reducing a balance remaining to meet the minimum spending criteria is a best option to maximize the collective financial benefit.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

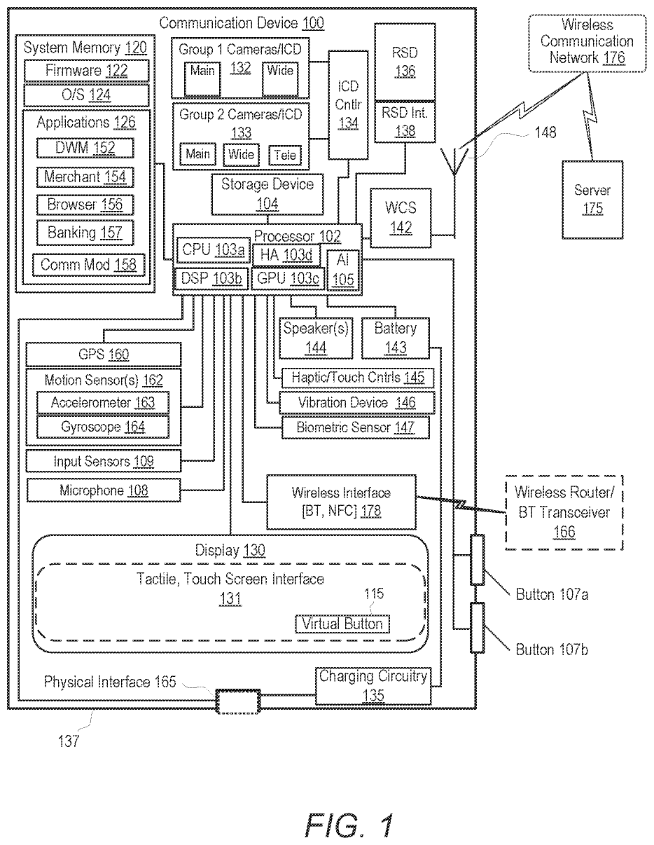

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components that enable the device to provide credit card management, according to one or more embodiments. Examples of electronic device 100 include, but are not limited to, mobile devices, a notebook computer, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can interchangeably be referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Controller 102 is communicatively coupled to storage device 104, system memory 120, input devices (introduced below), output devices, including integrated display 130, and image capture device (ICD) controller 134.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. Throughout the disclosure, the term image capturing device (ICD) is utilized interchangeably to be synonymous with and/or refer to any one of the cameras 132, 133. Both sets of cameras 132, 133 include image sensors that can capture images that are within the field of view (FOV) of the respective camera 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, digital wallet module (DWM) 152, other applications, indicated as merchant app 154, browser app 156, banking app 157, and communication module 158. The merchant app can include an app for an online retailer, such as Amazon®, for example. The browser app can include an HTML browser for accessing one or more websites (e.g., Target.com) for completing electronic purchases using a payment source. A banking app can be used to retrieve banking information, such as current balances. In one or more embodiments, information retrieved from merchant app 154, browser app 156, and/or banking app 157, can be used as criteria for recommending a payment source to use for a particular transaction. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, digital wallet module (DWM) 152 includes program instructions for providing credit card management, including determining a best payment source to use for a proposed purchase, in order to maximize collective financial benefit.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more of the applications (e.g., 152, 154, 156, 158) and specifically digital wallet module (DWM) 152 stored thereon. Processor 102 can access RSD 136 to provision electronic device 100 with program code that, when executed/processed by processor 102, the program code causes or configures processor 102 and/or generally electronic device 100, to provide the various credit card management functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 115. In one or more embodiments, when a user applies a finger on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons, indicated as 107a and 107b. While two buttons are shown in FIG. 1, other embodiments may have more or fewer input buttons. Microphone 108 can also be referred to as an audio input device. In some embodiments, microphone 108 may be used for identifying a user via voiceprint, voice recognition, and/or other suitable techniques. Input buttons 107a and 107b may provide controls for volume, power, and ICDs 132, 133. Additionally, electronic device 100 can include input sensors 109 (e.g., sensors enabling gesture detection by a user).

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 176 via transmissions of communication signals to and from network communication devices, such as base stations or cellular nodes, of wireless communication network 176. Wireless communication network 176 further allows electronic device 100 to wirelessly communicate with server 175, and other communication devices, which can be similarly connected to wireless communication network 176. In one or more embodiments, various functions that are being performed on communications device 100 can be supported using or completed via/on server 175.

Electronic device 100 can also wirelessly communicate, via wireless interface(s) 178, with wireless communication network 176 via communication signals transmitted by short range communication device(s). Wireless interface(s) 178 can be a short-range wireless communication component providing Bluetooth, near field communication (NFC), and/or wireless fidelity (Wi-Fi) connections. In one or more embodiments, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In one or more embodiments, WCS 142 with antenna(s) 148 and wireless interface(s) 178 collectively provide wireless communication interface(s) of electronic device 100.

Electronic device 100 of FIG. 1 is only a specific example of a device that can be used to implement the embodiments of the present disclosure. Devices that utilize aspects of the disclosed embodiments can include, but are not limited to, a smartphone, a tablet computer, a laptop computer, a desktop computer, a wearable computer, and/or other suitable electronic device.

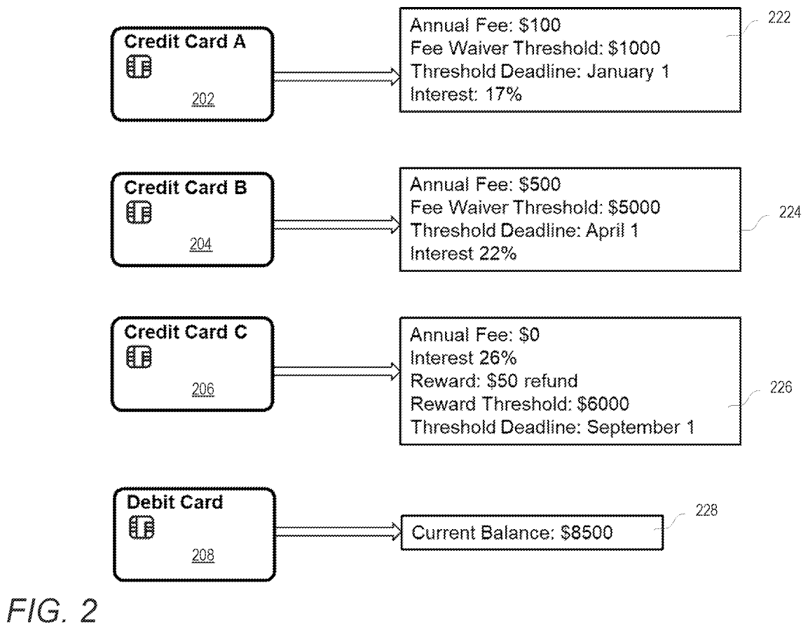

FIG. 2 depicts an example of multiple exemplary payment sources that are managed within a digital wallet, according to one or more embodiments. A first payment source, indicated as credit card A 202, has associated first payment source metadata 222. A second payment source, indicated as credit card B 204, has associated second payment source metadata 224. A third payment source, indicated as credit card C 206, has associated third payment source metadata 226. A fourth payment source, indicated as debit card 208, has associated fourth payment source metadata 228. Note that while four payment sources are shown in the example of FIG. 2, one or more embodiments may utilize more or fewer payment sources.

Payment sources indicated by 202, 204, and 206 are credit cards. Payment source 208 is a debit card. First payment source metadata 222 provides that credit card A 202 has an annual fee of $100, a fee waiver threshold of $1000, a threshold deadline of January 1, and an interest rate of 17 percent. In other words, credit card A 202 has an annual fee of $100, which will be waived if the user spends $1000 or more on credit card A 202 before January 1. Similarly, second payment source metadata 224 provides that credit card B 204 has an annual fee of $500, a fee waiver threshold of $5000, a threshold deadline of April 1, and an interest rate of 22 percent. In other words, credit card B 204 has an annual fee of $500, which will be waived if the user spends $5000 or more on credit card B 204 before April 1. Third payment source metadata 226 provides that credit card C 206 has no annual fee, and moreover, provides a $50 refund (e.g., a ‘cash back’ reward), if the user spends $6000 or more on credit card C on or before September 1. Fourth payment source metadata 228 presents a current balance (i.e., available money to spend) on debit card 208. In some scenarios, payment with the debit card may be the most effective payment mechanism. Accordingly, one or more embodiments may present a debit card as a preferred payment source based on various conditions. In addition to credit cards and debit cards, other payment sources may be included in disclosed embodiments, including, but not limited to, cryptocurrency payment sources, such as Bitcoin and/or Ethereum, and reward point balances.

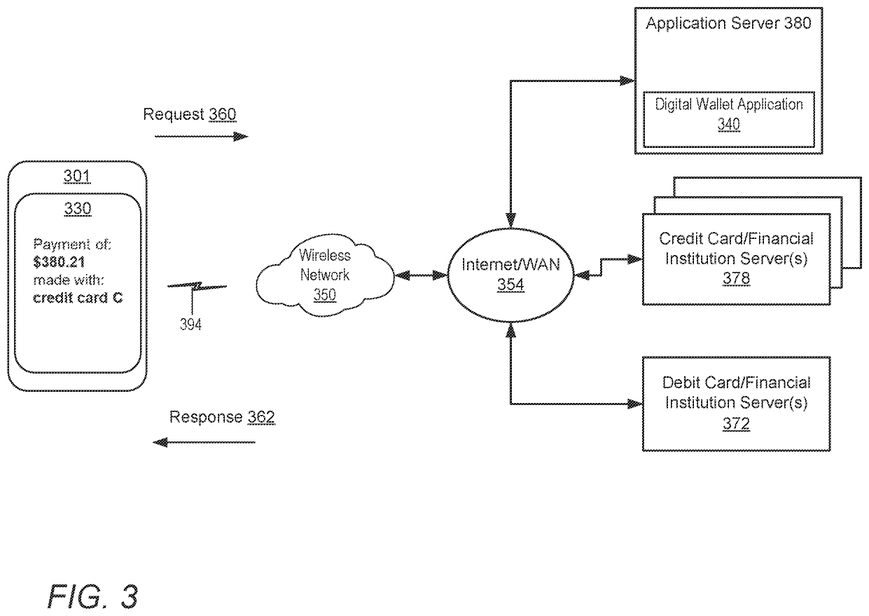

FIG. 3 is an example illustration of an electronic device transmitting a request for payment source data to an application computer system, such as a credit card financial institution server, and receiving a response from the application computer system for setting up payment source information in a digital wallet, according to one or more embodiments. Device 301 includes a display 330 on which digital wallet information is displayed. Device 301 can be an implementation of electronic device 100, having similar components and/or functionality. As indicated previously, in one or more embodiments, at least some of the digital wallet application may be implemented on a network-accessible application server, such as indicated by application server 380. Application server 380 is communicatively coupled to Internet/WAN 354. In one or more embodiments, Internet/WAN 354 can include one or more wide area networks (WANs) and/or the Internet. In one or more embodiments, electronic device 301 can communicate wirelessly with wireless network 350 via transmissions of communication signals 394 to and from network communication devices, such as base stations or cellular nodes, that can include components of network 350. Network 350 enables exchange of data between electronic device 301 and application server 380, via Internet/WAN 354.

Application server 380 can host a digital wallet application 340. The digital wallet application 340 can utilize account data obtained from one or more credit card/financial institution server(s) 378. via Internet/WAN 354. Furthermore, the digital wallet application 340 can utilize account data obtained from one or more debit card/financial institution server(s) 372. The account data obtained from servers 378 and/or servers 372 can include, but is not limited to, interest rate, periodic fee structures, fee waiver threshold limits, fee waiver deadlines and schedules (end/renewal date), current activity levels, current balance levels, transaction details, credit limits, and so on. A current balance level can indicate an amount (e.g., in USD) that is currently owed on the account associated with a payment source. A current activity level can represent the amount that has been charged to the account associated with a payment source over a given time period. As an example, an account can have a current balance of $76, meaning that there is currently $76 charged to the account that has not yet been paid, while the current activity level for the account can be $576, over a time period that can include multiple payment cycles. Continuing with this example, the current activity level can be for a calendar year, and the current activity level can represent all charges applied to the account during the year-to-date, indicating that $576 have been charged to the account, and of that $576, $76 has not yet been paid and remains as an outstanding balance.

The digital wallet application 340 can enable storing and/or editing of user preferences and/or usage patterns, such as if the user typically pays the balance in full to avoid interest charges, or typically makes partial payments and incurs interest charges. In one or more embodiments, when a transaction is initiated, the digital wallet application 340 can access data from servers 372 and/or 378, in order to make computations to derive recommendations and/or selections of a preferred payment source, in accordance with one or more embodiments. The digital wallet application 340 may further maintain historical data. The historical data can include purchase habit information of the user. The purchase habit information can include amounts typically spent, merchants typically used, categories of purchases made, timing of those purchases, and so on. Historical data can include the cost of one or more items or services that have been previously purchased by the user and/or at a particular merchant. In one or more embodiments, the digital wallet application 340 may utilize historical data as criteria for selecting and/or recommending a payment source to maximize the collective financial benefit received by the user.

In one or more embodiments, in addition to tracking transactions performed using the digital wallet application 340, disclosed embodiments also track external transactions. External transactions are ones that occur outside of the digital wallet application 340. The external transactions can include purchases made with a physical credit card and/or a copy of the credit card, such as by an authorized second user of the credit card, as well as periodic payments, such as for memberships and/or subscriptions, that may be automatically charged to the card. Accordingly, by tracking all expenses charged to the credit card and not just the ones transacted using the digital wallet application 340, one or more embodiments can involve maintaining an accurate total of the amount spent and/or balance remaining on the credit card within a tracked period, in order to get periodic fees waived and/or earn a reward.

According to one aspect of the disclosure, electronic device 301 can transmit a request 360 to application server 380 for account data, user profile data, and/or historical data. The request can be triggered by the user entering a new payment account, and providing an account identifier and corresponding login credentials to access the payment account maintained at the financial server 372/378. Electronic device 301 can receive, in response to the request 360, a response 362 that contains the account data, user profile data, and/or historical data. Electronic device 301 and application server 380 can perform a validation and authentication routine prior to the exchange of data and information to provide account verification and security. In one or more embodiments, the request 360 and response 362 may utilize Hypertext Transfer Protocol (HTTP) and/or its secure counterpart HTTPS. Embodiments may use RESTful APIs, JavaScript Object Notation (JSON), Simple Object Access Protocol (SOAP), and/or other communication techniques for exchanging information. Once a financial account is initially set up on electronic device and/or within digital wallet, the device processor periodically requests updated account data to accurately track all expenses that may occur with the payment account, including expenses not run through the digital wallet application 340.

In one or more embodiments, in order to support scalability and/or ease of maintenance, application server 380 may be implemented via virtualization, such as utilizing hypervisors like VMware, Hyper-V, or KVM. One or more embodiments may include containerization services such as docker, LXC, or other suitable container framework to enable multiple isolated user-space instances. Additionally, one or more embodiments may include load balancing and/or orchestration, such as utilizing Kubernetes, or other suitable orchestration framework.

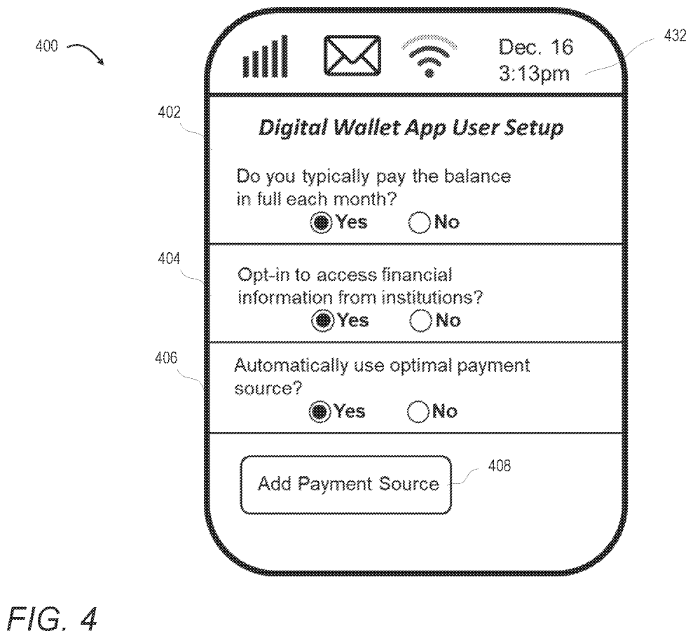

FIG. 4 illustrates an exemplary user interface 400 of electronic device 100 presenting optimal payment source feature setup for a digital wallet application, according to one or more embodiments. In one or more embodiments, the user interface shown in FIG. 4 may be rendered on a device such as device 100 of FIG. 1, or device 301 of FIG. 3. The user interface 400 shown in FIG. 4 can include numerous configuration fields, including a payment habit field 402. In one or more embodiments, the payment habit field 402 includes a setting to indicate if a user typically pays account balances in full before interest charges are incurred. The information in payment habit field 402 can be used as a criterion for determining which payment source provides the maximum collective financial benefit for a given purchase. For example, payment habit field 402 provides a YES or NO selection for user selection of whether the user typically pays off the entire balance of a credit card in full. If the selection in payment habit field 402 is ‘NO,’ then the interest rate associated with each of the possible payment sources in the digital wallet may be considered in determining which payment source provides the maximum collective financial benefit for a given purchase. If instead, the selection in payment habit field 402 is ‘YES’, then the interest rate associated with each of the possible payment sources in the digital wallet may be ignored when determining which payment source provides the maximum collective financial benefit for a given purchase, since interest charges will not be accrued.

The user interface 400 shown in FIG. 4 can include opt-in field 404. In one or more embodiments, if the setting in opt-in field 404 is set to ‘YES,’ then the digital wallet application executing on an electronic device (e.g., 301 of FIG. 3) retrieves financial information, account data, user profile data, historical data, and/or other relevant data, from one or more servers of corresponding financial institutions, such as depicted in FIG. 3. If instead, the opt-in field 404 is set to ‘NO,’ then the digital wallet application may perform payment source selection and/or recommendations based on user-provided information, without accessing financial information from outside sources. In this way, disclosed embodiments enable a user to control the level of information that is shared with the digital wallet application.

The user interface 400 shown in FIG. 4 can include an automatic payment source selection field 406. In one or more embodiments, if the selection in automatic payment source selection field 406 is ‘YES,’ then the transaction is completed with the selected payment source. For example, when a user attempts to make a purchase using his/her electronic device, such as using near field communication (NFC) that interacts with a payment terminal, while the automatic payment source selection field 406 is set to ‘YES,’ then the payment source that is identified as having maximum collective financial benefit may be automatically used to complete the transaction (e.g., purchase). Similarly, when a user attempts to make a purchase using his/her electronic device, such as using near field communication (NFC) that interacts with a payment terminal, while the automatic payment source selection field 406 is set to ‘NO,’ then the payment source that is identified as having maximum collective financial benefit may be indicated to the user, and the user is provided with an option to use the indicated payment source, or select another option for making a payment to complete the transaction.

The user interface 400 shown in FIG. 4 can include an add payment source button 408. The add payment source button 408, when invoked, enables a user to enter payment source metadata. The payment source metadata can include account numbers, expiration dates, security codes, security questions/answers, credit limits, interest rates, annual fees, reward structures, and/or other relevant information. In one or more embodiments, multiple payment sources may be added. In one or more embodiments, some or all of the payment source metadata may be automatically retrieved from the corresponding financial institution. The payment sources can include credit cards, debit cards, cryptocurrency accounts, reward points accounts, investment accounts, savings accounts, and/or other types of accounts. One or more embodiments can include: presenting a first graphical user interface (GUI) on the display for setting up payment sources within the digital wallet; receiving data input corresponding to a first payment source to add to the digital wallet; transmitting, to a server supporting transactions via the first payment source, a request for additional first payment source data, the first payment source data including used credit, available credit, total credit, the minimum spending criteria, the end/renewal date for the tracked period, and fees associated with expiration of the tracked period when the minimum spending criteria is not met.

The user interface 400 shown in FIG. 4 can display a current date (and time) 432. In one or more embodiments, the current date 432 is a criterion used in determining which payment source provides the maximum collective financial benefit for a given purchase as of the present date. In one or more embodiments, the digital wallet application computes how many days are remaining until a fee waiver threshold deadline, reward threshold deadline, or other relevant deadline. Based at least in part on how many days are remaining, a payment source can be selected. For example, in a case where a user is very close to reaching the usage level that will result in a fee being waived for a given payment source, and the time remaining is less than a predetermined time duration (e.g., less than a week), then that payment source can be prioritized for usage for purchases until the threshold is reached. Once the threshold is reached, and the periodic fee for that payment source is waived, then another payment source may become the prioritized payment source, until the conditions are met for that other payment source to have its periodic fee waived. The analysis of payment sources may continue, with the goal of reducing fees and maximizing rewards for the payment sources, thereby serving to maximize the collective benefit, such as a collective financial benefit and/or a non-financial benefit.

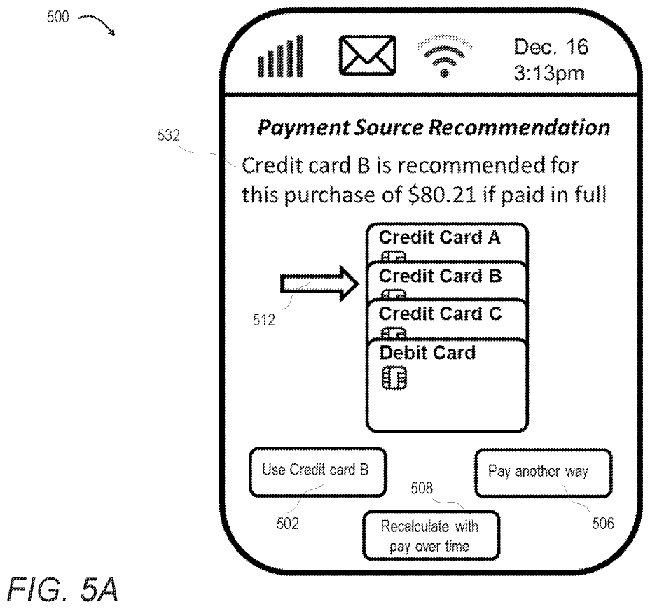

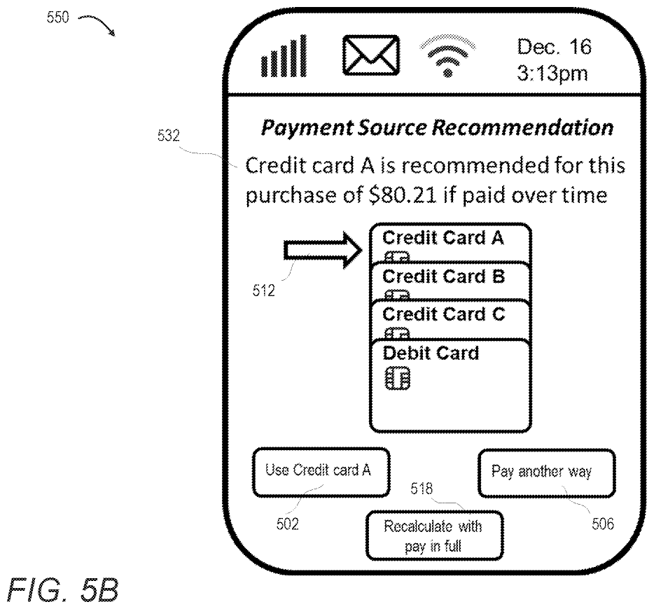

FIG. 5A illustrates an exemplary user interface 500 for providing payment source recommendation within a digital wallet when a pay in full option is selected, according to one or more embodiments. In one or more embodiments, the user interface shown in FIG. 5A may be rendered on an electronic device such as device 100 of FIG. 1 or device 301 of FIG. 3. The user interface 500 shown in FIG. 5A can include a payment source recommendation field 532 that indicates, via a text string, which payment source is currently being recommended to use for a given purchase. Recommendation field 532 can serve as a digital wallet alert indicating/suggesting that the financial transaction be completed via the indicated payment source. The user interface 500 may further include a graphical indicator 512 that highlights and/or indicates which payment source is currently being recommended to use for a given purchase. The user interface 500 may include button 502 for selecting the currently recommended payment source to complete a financial transaction. When button 502 is invoked, the digital wallet application completes the financial transaction using the recommended payment source (credit card B in this example). Embodiments can include retrieving data providing a respective opportunity cost to utilize each of the plurality of payment sources available to complete the financial transaction; ranking each of the plurality of payment sources based on the respective opportunity cost; presenting, on the display, a graphical user interface of the digital wallet, including a listing of each of the plurality of payment sources available to complete the financial transaction along with the respective opportunity cost; and enabling selection by a user of the electronic device of a specific one of the plurality of available payment sources.

The user interface 500 may include override button 506. The override button 506 enables the user to select a different payment source than the payment source that was recommended. In one or more embodiments, when the override button 506 is invoked, the user interface renders an option to select one of the other payment sources in the digital wallet to use for completing the transaction. In this way, a user can retain full control over which payment source is used, and when.

The user interface 500 may include a recalculate button 508. In one or more embodiments, the recalculate button 508 recalculates the optimal payment source based on paying over time, meaning that interest charges may be incurred. In this way, even when the general user preference of paying in full (avoiding the incurring of interest charges) is selected (e.g., option ‘YES” in 402 of FIG. 4), the user still has an option to indicate that a particular purchase may be paid back over time, thereby providing flexibility on how a particular purchase will be paid and which payment source provides the best option for that extended payment. For example, a user may typically pay his/her balance in full to avoid incurring interest charges. However, when making a large purchase, a user may opt to pay over time. Disclosed embodiments provide the user with the flexibility to accommodate these situations, while still selecting the optimal card for the purchase transaction.

One or more embodiments can include generating and presenting a first digital wallet alert indicating that the financial transaction be completed via the first payment source and presenting additional information regarding a benefit of reducing or meeting the minimum spending criteria by utilizing the first payment source to complete the financial transaction, in response to identifying that completion of the financial transaction via the first payment source is preferred to meet the minimum spending criteria.

FIG. 5B illustrates an exemplary user interface 550 providing payment source recommendation within a digital wallet indicating a recommended payment source if a given purchase is to be paid in full, according to one or more embodiments. In one or more embodiments, the user interface 550 may be rendered on a device such as device 100 of FIG. 1, or device 301 of FIG. 3. The user interface of FIG. 5B can include a payment source recommendation field 532 that indicates, via a text string, which payment source is currently being recommended to use for a given purchase. The user interface 550 of FIG. 5B may further include a graphical indicator 512 that highlights and/or indicates which payment source, among a plurality of presented payment options, is currently being recommended to use for a given purchase. The user interface 550 of FIG. 5B may include a button 502 which enables user selection of the currently recommended payment source to complete a financial transaction. When button 502 is invoked, the digital wallet application completes the financial transaction using the recommended payment source (credit card A in this example).

The user interface 550 of FIG. 5B may include an override (“pay another way”) button 506. The override button 506 enables the user to select a different payment source than the payment source that was recommended. In one or more embodiments, when the override button 506 is invoked, the user interface renders an option (e.g., a drop-down list of available payment sources) to select one of the other payment sources in the digital wallet to use for completing the transaction. In this way, a user can retain full control over which payment source is used, and when.

The user interface 550 of FIG. 5B may include a recalculate button 518. In one or more embodiments, the recalculate button 518 recalculates the optimal payment source based on paying in full, which avoids incurring of interest charges on the remaining payment balance. In this way, even when the general user preference of paying over time (incurring interest charges) is selected (e.g., option ‘NO’ in 402 of FIG. 4), the user still has an opportunity to indicate that a particular purchase may be paid in full, thereby providing flexibility on how a particular purchase will be paid back. For example, a user may typically pay his/her balance over time, which incurs interest charges. However, when a user has acquired additional funds (e.g., via a bonus from his/her work) or the amount of the transaction is one that the user can pay in full, a user may opt to pay in full to avoid interest charges. Disclosed embodiments provide the user with the flexibility to accommodate these situations. Depending on if the user plans to pay off the credit card balance in full or over time can affect which payment source is recommended. Referring to the example payment source data shown in FIG. 2, first payment source, indicated as credit card A 202, has associated payment source metadata 222 that indicates an interest rate of 17 percent, whereas credit card B 204, has associated payment source metadata 224 that indicates an interest rate of 22 percent. When paying in full, the digital wallet app may recommend credit card B as the preferred payment source, due to its high annual fee, such that the user can work towards getting a fee waiver without having to worry about having to incurred the higher interest rate (as indicated in FIG. 5A). However, when the user pays off the credit card balance over time, the wallet app may recommend credit card A as the preferred payment source, due to its lower interest rate, such that the user can reduce the amount of interest incurred during the extended payment timeframe (as indicated in FIG. 5B), which may, under the circumstance of an extended payment timeframe, provide more financial benefit than getting a periodic fee waived on a credit card with a high interest rate. Thus, one or more embodiments can consider whether the rate of interest accrual by a particular payment source exceeds the amount of a fee waiver that can be obtained by using a different payment source, and select the payment source that achieves the maximum collective financial benefit. Accordingly, disclosed embodiments can dynamically recalculate a preferred payment source based on specific conditions established by a user, thereby providing flexibility in payment source selection, while still guiding the user towards a maximum collective financial benefit.

In one or more embodiments, for a given purchase, a score is computed for each payment source, and the highest score indicates the preferred payment source to be used. In one or more embodiments, the score S is computed as:

$$S = \frac{kF}{DT}$$

Where:
F is the periodic fee;
D is the number of days until the threshold date;
T is the threshold balance (how much more account activity is required to waive a fee or earn a reward); and
k is a constant that can be adjusted based on the desired scale and magnitude of the score.

Other embodiments may include additional formulas instead of, or in addition to the aforementioned formula, for including other factors. For example, some formulas may include a factor based on purchase amount, interest rate, and periodic fee. In cases where the incurred interest, based on purchase amount and interest rate, exceeds a certain percentage of the periodic fee, then a payment source with a reduced interest rate may be selected. In contrast, where the incurred interest, based on purchase amount and interest rate, is less than or equal to a certain percentage of the periodic fee, then a payment source with a high periodic fee may be selected, to enable the user to progress towards waiving of the high periodic fee. Other financial criteria may also be considered, in one or more embodiments, for the purposes of determining a preferred payment source to be used for completing a given financial transaction. In one or more embodiments, a score for a reward is computed in a similar manner. One or more embodiments can include updating a relative selection potential of the first payment source relative to each other payment source of the plurality of payment sources, in part based on an amount remaining to reach the minimum spending criteria, a relative closeness of the end/renewal date, and a spending pattern identified over a monitored period, in response to the digital wallet performing payment source selection based on a ranking scheme that factors in a proximity of the total spend amount within the tracked period using the first payment source and the minimum spending criteria.

One or more embodiments may further include a purchase category as part of the analysis. As an example, some credit cards offer additional incentives on certain types of purchases (e.g., gasoline, restaurants, etc.). In one or more embodiments, an additional factor is included in the computation for the score S and/or a value of a coefficient is adjusted if it is determined that the purchase is in a category that earns additional rewards beyond a default reward amount. One or more embodiments may further include a merchant category as part of the analysis. As an example, some credit cards may offer additional incentives on purchases made at a particular merchant. In one or more embodiments, an additional factor is included in the computation for the score S and/or a value of a coefficient is adjusted if it is determined that the purchase is made from a merchant that earns additional rewards beyond a default reward amount. In one or more embodiments, a Merchant Category Code (MCC) that is provided by the payment processor is used as a criterion in determining a merchant and/or category. An MCC can be assigned by a payment processor based on the type of business conducted by the merchant. MCCs provide a broad categorization (e.g., grocery stores, clothing stores) of a purchase type and/or merchant that can be used to further optimize the scoring of multiple payment sources.

One or more embodiments may enable additional customizations and/or user-defined prioritizations regarding the determination of a recommended payment source. The customizations can include using a particular payment source for a given product category (e.g., fuel). The customizations can include non-financial criteria. That is, criteria that may not have a direct financial benefit to a user. This can include scenarios such as payment sources that donate to a given charity when used, and/or promote a cause on social media when used for a purchase, and so on.

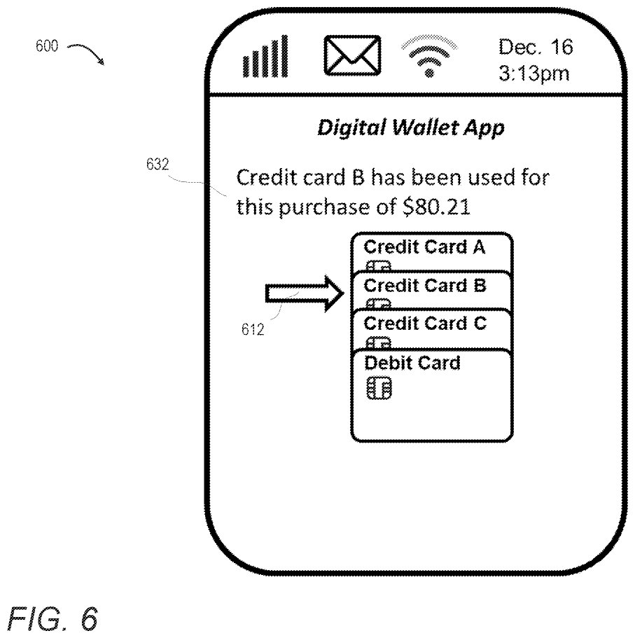

FIG. 6 illustrates an exemplary user interface 600 providing payment source confirmation within a digital wallet, according to one or more embodiments. In one or more embodiments, the user interface 600 may be rendered on a device such as device 100 of FIG. 1, or device 301 of FIG. 3. The user interface 600 can include a payment source confirmation field 632, which indicates which payment source was used to complete a purchase. Moreover, the user interface of FIG. 6 may further include a graphical indicator 612 that highlights and/or indicates which payment source among a plurality of payment sources has been used to make a given purchase. A payment sequence can include a ‘user's journey’ as he/she completes a transaction using a digital wallet. The payment sequence can include multiple steps, such as receiving a recommendation for a payment source, using the recommended payment source, selecting a different payment source for completing the transaction, cancelling the transaction, and/or other steps. In one or more embodiments, a payment sequence can include recommending a payment source as a user is about to make a purchase using his/her device, such as depicted in FIG. 5A and/or FIG. 5B. The user can opt to pay with the recommended payment source or to select a different payment source. Then, once the purchase transaction is completed, the user is presented with a user interface such as the user interface 600 that indicates and confirms which payment source was used for a purchase. The aforementioned payment sequence can occur when the user has set the option in field 406 of FIG. 4 to ‘NO,’ indicating that the user wants to review the decision of the digital wallet module (DWM) before the purchase is made.

In one or more embodiments, the user can set the option in field 406 of FIG. 4 to ‘YES,’ indicating that the user wants to automatically use the payment source determined by the digital wallet module (DWM) to make the purchase. In the payment sequence with the option in field 406 of FIG. 4 set to ‘YES,’ the user is presented with a user interface such as the user interface 600 of FIG. 6 that indicates and confirms which payment source was used for a purchase, without being first presented with a user interface for payment source recommendation, such as the user interface 500 shown in FIG. 5A.

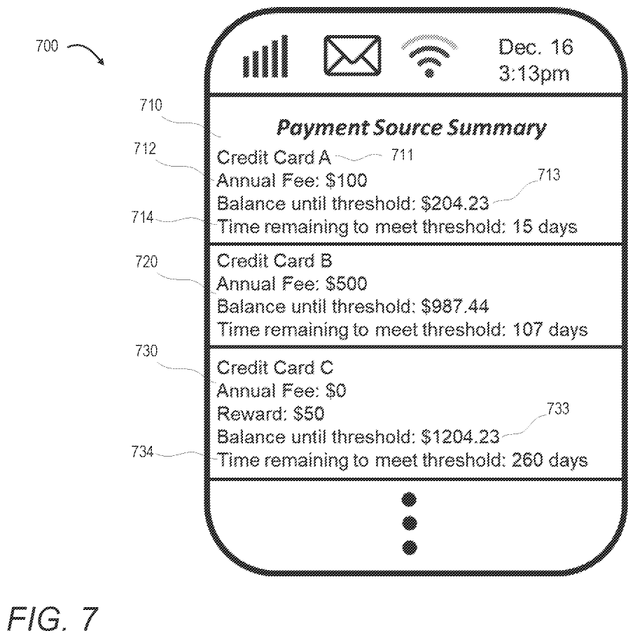

FIG. 7 illustrates an exemplary user interface 700 presenting payment source summary information within a digital wallet, according to one or more embodiments. In one or more embodiments, the user interface 700 may be rendered on a device such as device 100 of FIG. 1, or device 301 of FIG. 3. The user interface 700 can include a payment source summary. The payment source summary can include payment source summary field for each payment source that the user has loaded into the digital wallet. In the example depicted in FIG. 7, three payment source summary fields are shown, indicated at 710, 720, and 730. In practice, there can be more or fewer payment source summary fields, depending on how many payment sources the user has loaded into the digital wallet. The payment source summary field for a given payment source can indicate a variety of information, including, but not limited to, a credit card name, a periodic fee amount, a balance until a fee waiver threshold is met, a balance until a reward threshold is met, and/or a duration (e.g., in number of days) until the corresponding fee waiver threshold deadline and/or reward threshold deadline. An example of a credit card name is indicated at 711. An example of a periodic fee is indicated at 712. An example of a balance until a fee waiver threshold is met is indicated at 713. Each time a purchase is completed using a given card, the balance needed to reach a fee waiver threshold can be updated. Embodiments can include updating a balance remaining to reach the minimum spending criteria to account for an actual amount utilized to complete the financial transaction, in response to completion of the financial transaction using the first payment source. An example of a balance until a reward threshold is met is indicated at 733. An example of a duration until a fee waiver threshold deadline occurs is indicated at 714. An example of a duration until a reward threshold deadline occurs is indicated at 734.

One or more embodiments may provide additional recommendations, based on information such as payment source usage history (how often a user has used a particular payment source, and how much was typically spent). In cases where the usage history indicates a low usage rate for a card that incurs annual fees, disclosed embodiments may generate a recommendation for the user to cancel that payment source to avoid incurring periodic fees. One or more embodiments may recommend a composite purchase. A composite purchase can include a partial payment with a first payment source, and a partial payment with a second payment source, in order to complete a purchase. As an example, if a user is about to spend $500, the digital wallet module (DWM) (152 of FIG. 1) may identify that two of the user's payment sources are $200 and $350 away, respectively, from reaching a fee waiver threshold, with the remaining time for the second payment source to meet the threshold being longer than the time for the first payment source. In such a scenario, the digital wallet module (DWM) may generate a recommendation to put $200 on the first payment source and $300 on the second payment sources, so that at least one payment source is able to waive its corresponding periodic usage fee, while the other payment source, with a longer remaining time, approaches the spend amount to waives its periodic usage fee. One or more embodiments may include additional features for maximizing the collective financial benefit.

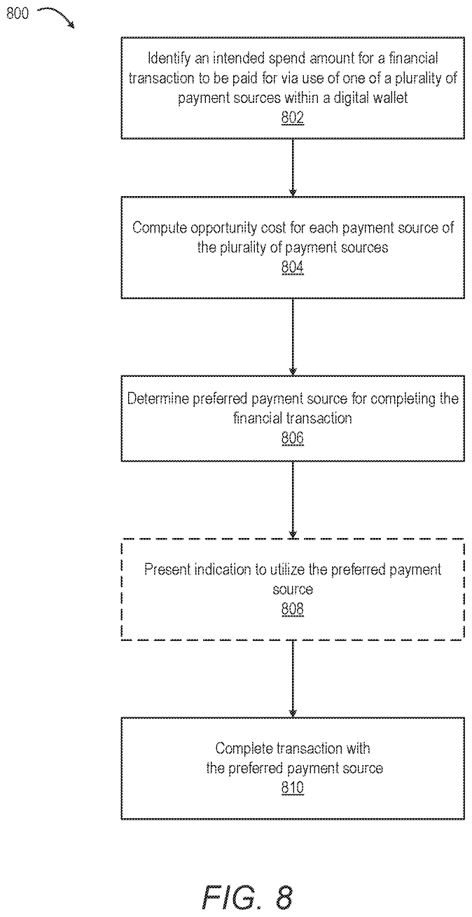

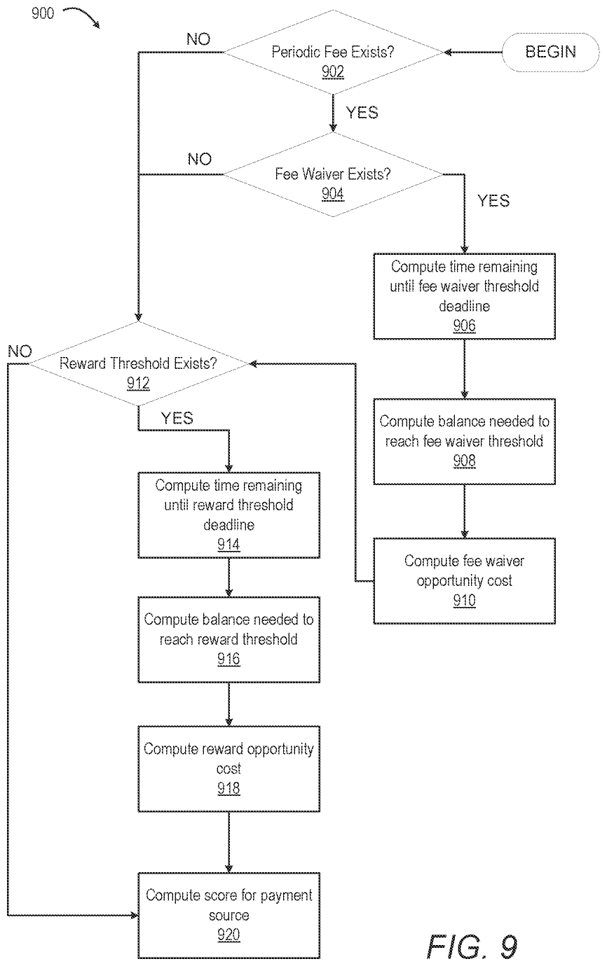

Referring now to the flowcharts presented by FIG. 8 and FIG. 9, the descriptions of the methods in FIG. 8 and FIG. 9 are provided with general reference to the specific components and features illustrated within the preceding FIGS. 1-7. Specific components referenced in the methods of FIG. 8 and FIG. 9 may be identical or similar to components of the same name used in describing preceding FIGS. 1-7. In one or more embodiments, processor 102 (FIG. 1) configures electronic device 100 (FIG. 1) to provide the described functionality of the methods of FIG. 8 and FIG. 9 by executing program code for one or more modules or applications provided within system memory 120 of electronic device 100, including digital wallet module (DWM) 152 (FIG. 1).

FIG. 8 depicts a flowchart of method 800 for identifying a payment source to be used to maximize collective financial benefit, according to one or more embodiments. The method 800 starts at block 802, where an intended spend amount is identified for a financial transaction to be paid for via use of one of a plurality of payment sources within a digital wallet. In one or more embodiments, identifying the intended spend amount further includes: detecting initiation of an intended transaction that involves payment using the digital wallet; and retrieving at least one financial data from one of the intended transactions, where the at least one financial data includes a determined location of the intended transaction, a date and/or time of the intended transaction; and determining the intended spend amount from the at least one financial data. The method 800 continues to block 804, where an opportunity cost for each payment source of the plurality of payment sources is computed. The computing of the opportunity cost can include computing a fee or other penalty that can be assessed by an administrator of a payment source if one or more conditions are not met. The fee waiving conditions can include an amount of money spent using the payment source, a number of times per a given period (e.g., monthly) that the payment source is used, and so on. The opportunity cost can also include rewards that can be earned if certain conditions are met. The rewards earning conditions can include an amount of money spent using the payment source, a number of times per a given period (e.g., monthly) that the payment source is used, and so on. In one or more embodiments, potential rewards are represented as a negative opportunity cost, and potential fees/penalties/interest incurred are represented as a positive opportunity cost. The method 800 continues with determining the preferred payment source for completing the financial transaction at block 806. In embodiments, the determining is based on the opportunity cost. One or more embodiments attempt to minimize the opportunity cost, in that the lower the opportunity cost, the greater the collective financial benefit. The method 800 continues with presenting, on an output device of the electronic device, an indication to utilize the preferred (recommended) payment source at block 808. The presenting of the indication can include rendering a user interface such as that shown in FIG. 5A and/or FIG. 5B. The method 800 continues with completing the transaction with the preferred (recommended) payment source at block 810. The completing of the transaction can include rendering a user interface such as that shown in FIG. 6. Alternatively, in one or more embodiments, block 808 can be omitted, and the method 800 can proceed from block 806 to block 810, skipping block 808. One or more embodiments can include automatically completing the financial transaction using the indicated (preferred) payment source.

FIG. 9 depicts a flowchart of an additional method 900 for computing a score used for ranking a payment source. In one or more embodiments, for each available payment source in a digital wallet, a score is computed, based on various criteria, such as periodic fees, rewards, interest rates, and the like. In one or more embodiments, the computed score is used to identify which payment source from amongst multiple available payment sources is the payment source that achieves the maximum financial benefit. The method 900 starts at block 902, where a check is made to determine if a periodic fee exists. If, at block 902, it is determined that a periodic fee exists, then the method continues to block 904, where a check is made to determine if a fee waiver condition exists. Some payment sources may have a periodic usage fee that cannot be waived. If, at block 904, it is determined that a fee waiver condition exists, then the method 900 continues to block 906, where a remaining time until the fee waiver threshold deadline occurs is computed. In one or more embodiments, the fee waiver threshold deadline can be the end of a tracked/monitored period. The computing of remaining time can include identifying a current time of day. In one or more embodiments, the current date can be identified via a global positioning system (GPS) module (e.g., 160 of FIG. 1), network time protocol (NTP) server, or other suitable technique. In one or more embodiments, the fee waiver threshold deadline is represented as a date. In one or more embodiments, the current date is subtracted from the fee waiver threshold deadline to determine a number of days remaining until the fee waiver threshold deadline. In one or more embodiments, the fee waiver threshold represents the level of spending/activity required to waive a periodic usage fee. The method 900 then continues to block 908, where the balance needed to reach the fee waiver threshold is computed. In embodiments, the balance computation can include subtracting a current balance over a given usage period from a fee waiver threshold balance for that usage period. As an example, if a credit card has an annual fee that is waived if the user spends $5,000 on that credit card over a 12-month period, and the user has currently spent $3,800 over the first 10-month period, then the balance needed to get the periodic fee waived is computed as 5000-3800=$1,200. In one or more embodiments, the current spending over the usage period is obtained from an application server (e.g., 380 of FIG. 3) and/or another payment processing system, and passed to an electronic device (e.g., 301 of FIG. 3). The method 900 then continues to block 910, where a fee waiver opportunity cost is computed. In one or more embodiments, the fee waiver opportunity cost is the amount of the periodic fee. However, in one or more embodiments, other factors, such as current interest rate for the payment source, may also be considered when computing an opportunity cost. For example, if the user is planning to pay back the payment source over time, then interest charges may apply, and the interest rate of the payment source can be considered when computing the opportunity cost. If instead, the user is planning to pay back the payment source in full before interest charges may apply, then the interest rate of the payment source is not considered when computing the opportunity cost.

The method 900 then continues to block 912, where a check is made to determine if a reward threshold exists. The method 900 also continues to block 912 if at block 902 it is determined that no periodic fee exists. Additionally, the method 900 also continues to block 912 if at block 904 it is determined that no fee waiver exists. If at block 912, it is determined that a reward threshold exists, the method 900 continues with computing the time remaining until the reward threshold deadline, at block 914. In one or more embodiments, the reward threshold deadline is represented as a date. In one or more embodiments, the current date is subtracted from the reward threshold deadline to determine a number of days remaining until the reward threshold deadline. The method 900 continues to block 916, where a balance needed to reach the reward threshold is computed. In one or more embodiments, the balance computation can include subtracting a current balance over a given usage period from a reward threshold balance for that usage period. As an example, if a credit card has a reward in the form of $50 cash back when the user spends $5,000 on that credit card over a 12-month period, and the user has currently spent $2,600 over the first 6 months of that 12-month period, then the balance needed to obtain the reward is computed as 5000-2600=$2,400. The method 900 continues with computing a reward opportunity cost at block 918. In one or more embodiments, the reward opportunity cost is the amount of the reward. The reward can be a cash reward or a non-cash reward such as points, free items, coupons, and/or other non-cash rewards. In one or more embodiments, for non-cash rewards, a cash equivalent value (CEV) may be computed. For example, if the reward is two free movie tickets, then a CEV may be computed as $30 based on an estimated value of $15 per movie ticket. In one or more embodiments, the CEV may be obtained via a look up table on application server 380 of FIG. 3, where the look up table contains estimated values for various non-monetary reward items. The method 900 ends with the processor computing the score for the payment source at block 920. The score computation may use a formula such as described previously. In one or more embodiments, artificial intelligence, such as provided by dedicated artificial intelligence (AI) engines 105 (FIG. 1) may be used to compute a score, and/or otherwise determine a preferred payment source based on a variety of input conditions, including, but not limited to, the periodic fee and/or reward amount, the balance remaining until a fee waiver and/or reward threshold, an intended purchase amount, a merchant, a purchase category, an interest rate, and so on. In one or more embodiments, based on the computed score of each available payment source, a preferred payment source is selected. In one or more embodiments, the preferred payment source is the payment source with the highest score. One or more embodiments include a ranking scheme based on the computed score, where the highest score corresponds to the preferred payment source. One or more embodiments can include retrieving other payment source data, the other payment source data including reward points and cash back offers; comparing the periodic account fee with a relative financial value of the other payment source data to complete the transaction; and presenting the indication to select the first payment source only in response to the periodic account fee being greater than the relative financial value of the other payment source data to complete the transaction.

As can now be appreciated, disclosed embodiments provide techniques for managing multiple payment sources in a digital wallet. At the time of a purchase, prior to completing the purchase transaction, disclosed embodiments determine a preferred payment source. The preferred payment source can be presented to the user as a recommendation. Alternatively, the preferred payment source can be automatically selected and used for completing the purchase transaction. Disclosed embodiments can save users money and reduce the cognitive workload associated with keeping track of numerous deadlines and limits with multiple payment sources. Disclosed embodiments can streamline the complexities associated with managing multiple payment sources. Accordingly, disclosed embodiments improve the technical field of digital wallet management.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
at least one output device, including a display;
a communication system;
a memory having stored thereon a digital wallet module presenting a suggested payment source to complete a financial transaction, from among a plurality of payment sources within a digital wallet, in part to minimize or eliminate incurring a periodic account fee of the suggested payment source; and
at least one processor communicatively coupled to the display, the communication system, and the memory, the at least one processor executing program code of the digital wallet module which enables the electronic device to:
identify an intended spend amount for a financial transaction to be paid for via use of one of the plurality of payment sources within the digital wallet, the plurality of payment sources comprising at least a first payment source that has a periodic account fee that is automatically applied at an end/renewal date of a tracked period, based on a total spend amount using the first payment source during the tracked period not reaching a minimum spending criteria;
determine, in part based on the intended spend amount, the minimum spending criteria, and the end/renewal date, a preferred payment source from among the plurality of payment sources to suggest for use in completing the financial transaction, while maximizing a collective financial benefit of selectively utilizing the plurality of payment sources within the digital wallet to complete financial transactions up to and following the end/renewal date; and
present, on an output device, an indication to utilize the first payment source in response to determining that reducing a balance remaining to meet the minimum spending criteria is a best option to maximize the collective financial benefit.

2. The electronic device of claim 1, wherein to present the indication to utilize the first payment source, the at least one processor:
retrieves data providing a respective opportunity cost to utilize each of the plurality of payment sources available to complete the financial transaction;
ranks each of the plurality of payment sources based on the respective opportunity cost;
presents, on the display, a graphical user interface of the digital wallet, comprising a listing of each of the plurality of payment sources available to complete the financial transaction along with the respective opportunity cost; and
enables selection by a user of the electronic device of a specific one of the plurality of available payment sources.

3. The electronic device of claim 1, wherein further the at least one processor:
in response to completion of the financial transaction using the first payment source:
updates a balance remaining to reach the minimum spending criteria to account for an actual amount utilized to complete the financial transaction.

4. The electronic device of claim 3, wherein the at least one processor:
in response to the digital wallet module performing payment source selection based on a ranking scheme that factors in a proximity of the total spend amount within the tracked period using the first payment source and the minimum spending criteria, updating a relative selection potential of the first payment source relative to each other payment source of the plurality of payment sources, in part based on an amount remaining to reach the minimum spending criteria, a relative closeness of the end/renewal date, and a spending pattern identified over a monitored period.

5. The electronic device of claim 1, wherein to identify an intended spend amount, the at least one processor:
detects initiation of an intended transaction that involves payment using the digital wallet; and
retrieves at least one financial data from the intended transaction, wherein the at least one financial data includes a determined location of the intended transaction, a date and/or time of the intended transaction; and
determines the intended spend amount from the at least one financial data.

6. The electronic device of claim 1, wherein the at least one processor:
in response to identifying that completion of the financial transaction via the first payment source is preferred to meet the minimum spending criteria, generates and presents a first digital wallet alert indicating that the financial transaction be completed via the first payment source and presenting information regarding a benefit of reducing or meeting the minimum spending criteria by utilizing the first payment source to complete the financial transaction.

7. The electronic device of claim 1, wherein the program code of the digital wallet module further enables the electronic device to:
present a first graphical user interface (GUI) on the display for setting up payment sources within the digital wallet.
receive data input corresponding to a first payment source to add to the digital wallet;
transmit, to a server supporting transactions via the first payment source, a request for additional first payment source data, the first payment source data comprising used credit, available credit, total credit, the minimum spending criteria, the end/renewal date for the tracked period, and fees associated with expiration of the tracked period when the minimum spending criteria is not met.

8. The electronic device of claim 1, wherein the program code of the digital wallet module further enables the electronic device to:
retrieve other payment source data, the other payment source data comprising reward points and cash back offers;
compare the periodic account fee with a relative financial value of the other payment source data to complete the transaction; and
present the indication to select the first payment source only in response to the periodic account fee being greater than the relative financial value of the other payment source data to complete the transaction.

9. The electronic device of claim 1, wherein the program code of the digital wallet module further enables the electronic device to automatically complete the financial transaction using the first payment source.

10. A method comprising:
identifying, by a processor of an electronic device that includes a display, an intended spend amount for a financial transaction to be paid for via use of one of a plurality of payment sources within a digital wallet, the plurality of payment sources comprising at least a first payment source that has a periodic account fee that is automatically applied at an end/renewal date of a tracked period, based on a total spend amount using the first payment source during the tracked period not reaching a minimum spending criteria;
determining, in part based on the intended spend amount, the minimum spending criteria, and the end/renewal date, a preferred payment source from among the plurality of payment sources to suggest for use in completing the financial transaction, while maximizing a collective financial benefit of selectively utilizing the plurality of payment sources within the digital wallet to complete financial transactions up to and following the end/renewal date; and
presenting, on an output device, an indication to utilize the first payment source in response to determining that reducing a balance remaining to meet the minimum spending criteria is a best option to maximize the collective financial benefit.

11. The method of claim 10, further comprising:
retrieving data providing a respective opportunity cost to utilize each of the plurality of payment sources available to complete the financial transaction;
ranking each of the plurality of payment sources based on the respective opportunity cost;
presenting, on the display, a graphical user interface of the digital wallet, comprising a listing of each of the plurality of payment sources available to complete the financial transaction along with the respective opportunity cost; and
enabling selection by a user of the electronic device of a specific one of the plurality of available payment sources.

12. The method of claim 10, further comprising updating a balance remaining to reach the minimum spending criteria to account for an actual amount utilized to complete the financial transaction, in response to completion of the financial transaction using the first payment source.

13. The method of claim 12, further comprising updating a relative selection potential of the first payment source relative to each other payment source of the plurality of payment sources, in part based on an amount remaining to reach the minimum spending criteria, a relative closeness of the end/renewal date, and a spending pattern identified over a monitored period, in response to the digital wallet performing payment source selection based on a ranking scheme that factors in a proximity of the total spend amount within the tracked period using the first payment source and the minimum spending criteria.

14. The method of claim 10, wherein identifying the intended spend amount further comprises:
detecting initiation of an intended transaction that involves payment using the digital wallet; and
retrieving at least one financial data from the intended transaction, wherein the at least one financial data includes a determined location of the intended transaction, a date and/or time of the intended transaction; and
determining the intended spend amount from the at least one financial data.

15. The method of claim 10, further comprising generating and presenting a first digital wallet alert indicating that the financial transaction be completed via the first payment source and presenting information regarding a benefit of reducing or meeting the minimum spending criteria by utilizing the first payment source to complete the financial transaction, in response to identifying that completion of the financial transaction via the first payment source is preferred to meet the minimum spending criteria.

16. The method of claim 10, further comprising:
presenting a first graphical user interface (GUI) on the display for setting up payment sources within the digital wallet.
receiving data input corresponding to a first payment source to add to the digital wallet;
transmitting, to a server supporting transactions via the first payment source, a request for additional first payment source data, the first payment source data comprising used credit, available credit, total credit, the minimum spending criteria, the end/renewal date for the tracked period, and fees associated with expiration of the tracked period when the minimum spending criteria is not met.

17. The method of claim 10, further comprising:
retrieving other payment source data, the other payment source data comprising reward points and cash back offers;
comparing the periodic account fee with a relative financial value of the other payment source data to complete the transaction; and
presenting the indication to select the first payment source only in response to the periodic account fee being greater than the relative financial value of the other payment source data to complete the transaction.

18. The method of claim 10, further comprising automatically completing the financial transaction using the first payment source.

19. A computer program product comprising a non-transitory computer readable medium having program instructions that when executed by a processor of an electronic device comprising a display, configure the electronic device to perform functions comprising:
identifying an intended spend amount for a financial transaction to be paid for via use of one of a plurality of payment sources within a digital wallet, the plurality of payment sources comprising at least a first payment source that has a periodic account fee that is automatically applied at an end/renewal date of a tracked period, based on a total spend amount using the first payment source during the tracked period not reaching a minimum spending criteria;
determining, in part based on the intended spend amount, the minimum spending criteria, and the end/renewal date, a preferred payment source from among the plurality of payment sources to suggest for use in completing the financial transaction, while maximizing a collective financial benefit of selectively utilizing the plurality of payment sources within the digital wallet to complete financial transactions up to and following the end/renewal date; and
presenting, on an output device, an indication to utilize the first payment source in response to determining that reducing a balance remaining to meet the minimum spending criteria is a best option to maximize the collective financial benefit.

20. The computer program product of claim 19, further comprising program instructions for:
retrieving data providing a respective opportunity cost to utilize each of the plurality of payment sources available to complete the financial transaction;
ranking each of the plurality of payment sources based on the respective opportunity cost;
presenting, on the display, a graphical user interface of the digital wallet, comprising a listing of each of the plurality of payment sources available to complete the financial transaction along with the respective opportunity cost; and
enabling selection by a user of the electronic device of a specific one of the plurality of available payment sources.
